(19) United States
(12) Patent Application Publication
(10) Pub. No.: US 2009/0017200 A1
(43) Pub. Date: Jan. 15, 2009

(54) CERAMIC COATING FOR COMBUSTION BOILERS

(76) Inventors: Olaf BINKLE, Kirkel (DE); Stefan Faber, Saarbrucken (DE); Ralph Nonninger, Saarbrucken (DE); Romeo Volz, Waldgassen (DE); Karl Schwetz, Sulzberg (DE); Martin Engler, Kempten (DE); Helmut Schmidt, Saarbrucken (DE); Mesut Aslan, Hoheischweiler (DE); Robert Drumm, Saarbrucken (DE); Hareesh Nair, Saarbrucken (DE); Klaus Endres, Sulzbach (DE); Bernd Reinhard, Merzig-Brotdorf (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/236,386

(22) Filed: Sep. 23, 2008

Related U.S. Application Data
(63) Continuation of application No. 10/523,573, filed on Jan. 28, 2005.

(51) Int. Cl. B05D 3/02

(52) U.S. Cl. 427/142; 427/376.2; 427/376.4; 427/140

(57) ABSTRACT

A method for producing a ceramic coating of metallic and/or ceramic surfaces and products in reactors, process plants and combustion plants includes applying a mixture of fine-particle boron nitride, at least one inorganic binding agent of medium particle size in the nanometer range, containing substantially Al₂O₃, AlO(OH), ZrO₂, Y—ZrO₂, TiO₂, Fe₂O₃ and/or SnO₂ or an associated precursor compound and at least one solvent and/or water onto a metallic and/or ceramic surfaces or product, and burning the applied mixture into a coating through heating.

### BACKGROUND OF THE INVENTION

The invention concerns a method for producing a ceramic coating of metallic and/or ceramic surfaces and products in reactors, process systems and combustion systems, wherein a mixture of fine-particle boron nitride and an inorganic binding agent of medium particle size in the nanometer range and at least one solvent is applied onto the metallic and/or ceramic surface or the product, and the applied mixture is burnt into a coating through heating.

The invention also concerns a ceramic coating of metallic and/or ceramic surfaces in reactors, process systems and combustion systems, which contains a molten mass or a sintered product of fine-particle boron nitride and at least one inorganic binding agent of medium particle size in the nanometer range.

The boiler and incinerator chambers of reactors and combustion systems, preferably of waste incinerators and in process and industrial incinerators have a fireproof wall structure to separate the actual boiler chamber from the pipe units. This is necessary to protect the pipe wall made from steel from high temperatures and attack through corrosive gases and mainly through corrosive solids.

The steel pipe units to be protected are usually lined on a large surface area with e.g. pipe wall plates or fireproof substances, concrete or stones and the gaps are filled with concrete, glued with substances or loaded with air, as described in the German patent application 102 06 607.8. These pipe wall linings are ceramic products, in particular SiC plates, stones and ceramic substances.

In certain areas of the reactors, combustion and waste heat boilers, it is not possible to protect the steel pipe units through application of pipe wall plates or substances, or concrete. To counteract the corrosive action of detrimental gases also in this case, the steel is protected through resurface welding of alloys (so-called cladding). Cladding requires great effort and great expense, in particular, later cladding of existing boilers.

During operation of the reactors and boilers, in particular, in waste incinerators, corrosive solids and ash precipitate on the ceramic pipe wall plates, substances or stones as well as on the resurface-welded alloys or steel pipes, which inhibit heat transfer from the combustion chamber to the pipe wall. These precipitations must be removed at regular intervals, either during operation through water jets or more often during operation stop periods through sand-blasting, brushing etc. Both methods are very intricate and very expensive. Cleaning during operation stop periods requires long inoperative periods of the plant and also highest safety measures for the cleaning staff.

Surfaces which have dirt-rejecting properties or inhibit adhesion of solids are called easy-to-clean surfaces (low energy surfaces through utilization of the teflon effect) or lotus surfaces (micro structures of plants). These coatings are known in the art but since all of these coatings have an organic basic frame, these layers are not resistant to high temperatures and cannot be used in the present case.

It is therefore the underlying object of the present invention to develop a coating for the steel pipe units directly, and also for the fire-resistant pipe wall lining, which considerably decreases the above-described adhesion and therefore ensures e.g. a permanently uniform heat transfer. If the coating is directly applied onto the steel pipe units, it must also have corrosion-blocking properties. Application of the ceramic layer should be possible, in addition to the direct installation region of coated steel pipes and fireproof steel pipe linings, also directly in the boiler or reactor and should harden at the temperatures prevailing in the operating boiler to thereby prevent expensive repair works. These demands exceed by far prior art.

### SUMMARY OF THE INVENTION

This object is achieved in accordance with the invention through the claimed ceramic coating and the claimed method for producing a ceramic coating.

A ceramic mixture which contains fine-particle boron nitride powder, preferably of a primary particle size of between 50 nm and 50 μm, in particular between 500 nm and 5 μm, an inorganic binder system and at least one solvent, permits production of a coating material which can be applied in a manner known in the art, in particular through spraying, doctoring, roiling, immersion or flooding onto metallic and also onto ceramic surfaces. A layer which has been applied in this manner hardens at temperatures above 400° C. As described already in the German patent application 101 27 494.7, these layers can be used as high-temperature easy-to-clean layers.

The easy-to-clean property of the inventive layer is based on the presence of boron nitride particles which are concentrated in the uppermost layer of the coating. Inorganic nanoparticles serve as inorganic binder system, in particular nanoparticles of the compounds Al₂O₃, AlO(OH), ZrO₂, Y—ZrO₂, TiO₂, SiO₂, Fe₂O₃ and SnO₂, or an associated precursor compound which is converted into nanoparticles of one of the mentioned compounds during the production process. Alternatively, also glass-like binder systems on the basis of metal organyl compounds can be used.

All conventional alcohols and water can be used as solvent, preferably used are butoxyethanol, ethanol and water, and, with particular preference, a combination of these solvents.

The high-temperature easy-to-clean layer can be applied to the metallic pipe wall by e.g. initially cleaning the steel boiler e.g. by sand-blasting. The inventive coating is applied e.g. through spraying or rolling. The boiler is subsequently heated during normal operation such that the layer hardens on the metallic substrata. Since the inventive layer is also suited for later repair of damaged locations of an applied layer in the steel boiler, repair work is very simple. The mentioned work can be carried out at each revision or simply upon requirement.

The high-temperature easy-to-clean layer can be applied to the ceramically coated pipe wall by initially cleaning the steel boiler e.g. by sand-blasting, and subsequent coating through spraying or rolling. Also in this case, the normal temperature of an operated boiler is sufficient to condense the layer. Coating of the ceramic plates can also be effected already during production, i.e. when the ceramic plates, stones or substances, in particular the SiC plates, are burnt. Towards this end, the inventive layer is applied onto the stones through spraying, doctoring, immersion or rolling before the stones are burnt for completion.

### EXAMPLE 1

7.5 g boron nitride is absorbed in 14.55 g 2-butoxyethanol. 16.62 g of a second mixture, which consists of 2.88 g tetraetoxysilane, 9.86 g methyltriethoxysilane, 2.26 g nano-scale SiO₂ (particle diameter of 5 to 15 nm) and 1.62 g water are added to this mixture. After adding, the mixture is stirred for 30 minutes. After cleaning of the boiler chamber, the coating material is applied through spraying, doctoring or rolling. The layers applied in this fashion are compressed “in situ” during boiler operation. Alternatively, the layer can be compressed by a flame also before boiler operation.

### EXAMPLE 2

100 g nano-scale ZrO₂ (particle diameter 10 nm) is added in portions to 700 g of a nitric acid aqueous solution and then 200 g of boron nitride is added in portions while stirring. The sludge is thoroughly stirred for approximately one hour and then 88 g of a PVA solution of 30% by weight is added. The ceramic suspension may be applied to the substrate through a spraying process. Thermal hardening occurs after drying at room temperature.

The inventive step of the present invention may be regarded e.g. as the excellent properties of the proposed ceramic coating. The present method can be carried out with surprising ease and requires little work which is explained herein by means of the nano-scale zircon oxide, but is also true for the other inorganic compounds proposed as binding agent.

The nanoparticles of zircon oxide have a large surface of up to 250 m²/g and, in the product, 50% of their atoms is on the surface. This means that the diffusion (the cause of sintering or burning of ceramic) starts considerably earlier than diffusion of larger particles. Nano-scale zircon oxide is sintered to its theoretical density already at 1000° C., zircon oxide of a size in the μm range only at 1600° C. This means for a binding agent that the layer starts to harden already at a temperature of several hundred degrees less.

1-18. (canceled)

19. Method for producing a ceramic coating on metallic and/or ceramic surfaces and products in reactors, process plants and combustion plants, characterized in that a mixture of fine-particle boron nitride, at least one inorganic binding agent of medium particle size in the nanometer range, selected from the group consisting of Al₂O₃, AlO(OH), ZrO₂, Y—ZrO₂, TiO₂, SiO₂, Fe₂O₃ SnO₂ and an associated precursor compound and at least one solvent and/or water is applied onto the metallic and/or ceramic surfaces or the product, and the applied mixture is burned into a coating through heating during operation of the reactors process plants and combustion plants.

20. Method according to claim 19 characterized in that the surfaces of metallic pipe walls, ceramic pipe wall plates, stones and lining substances in reactors, process plants and combustion plants are provided with the coating.

21. Method according to claim 20, characterized in that the surfaces of parts of waste incinerators are provided with the coating.

22. Method for producing a ceramic coating of metallic and/or ceramic surfaces and products in reactors, process plants and combustion plants characterized in that a mixture of fine-particle boron nitride, at least one organo-metallic compound, used as inorganic binding agent, and at least one solvent and/or water is applied onto the metallic and/or ceramic surfaces or the product, and the applied mixture is burned into a coating through heating.

23. Method according to claim 19, characterized in that the inorganic binding agent has an average particle size of less than 100 nm.

24. Method according to claim 19, characterized in that the solvent is selected from the group consisting of ethanol, 1-propanol, 2-propanol, 2-butoxyethanol and water.

25. Method according to claim 24, characterized in that the solvent contains a mixture of ethanol, 2-butoxyethanol and water.

26. Method according to claim 19, characterized in that burning-in of the applied mixture is carried out before operational start of the reactor, process plant or combustion plant through heating to at least 400° C.

27. Method for repairing a ceramic coating of metallic and/or ceramic surfaces and products in reactors, process plants and combustion plants, characterized in that a damaged coating is repaired through partial or complete application of the coating on the damaged coating in accordance with claim 19.

28. Method according to claim 19, characterized in that the mixture is applied through rinsing, rolling, immersion and/or flooding.
